(19) United States
(12) Patent Application Publication
(10) Pub. No.: US 2014/0360820 A1
(43) Pub. Date: Dec. 11, 2014

(54) DISC ROTOR

(71) Applicants: ADVICS CO., LTD., Kariya-shi Aichi (JP); TOYOTA JIDOSHA KABUSHIKI KAISHA, Toyota-shi Aichi (JP)

(72) Inventors: Takashi Harada, Kariya-shi (JP); Masahito Mizuno, Kariya-shi (JP); Kenji Abe, Toyota-shi (JP); Koichi Hamasaki, Aichi (JP)

(73) Assignee: ADVICS CO., LTD., Kariya-shi (JP)

(21) Appl. No.: 14/372,682

(22) PCT Filed: Feb. 21, 2013
(86) PCT No.: PCT/JP2013/054329

§ 371 Date: Jul. 16, 2014

(30) Foreign Application Priority Data
Feb. 23, 2012 (JP) 2012-037695

(51) Int. Cl. F16D 65/12; C23C 8/34; C23C 8/80; C23C 8/02

(52) U.S. Cl. CPC F16D 65/125; C23C 8/02; C23C 8/34; C23C 8/80; F16D 2065/132
USPC 188/218 XL

(57) ABSTRACT

Provided is a disc rotor formed of graphite-containing cast iron and having high corrosion resistance. For a disc rotor formed of graphite-containing cast iron, after removal of graphite present adjacent a surface of the disc rotor through a graphite removing treatment, a nitride layer and an oxynitride layer are laminated one after another on the surface through a gas nitrocarburizing treatment.

### TECHNICAL FIELD

The present invention relates to a disc rotor formed of graphite-containing cast iron, for use in e.g. a disc brake of a vehicle.

### BACKGROUND ART

A conventional component formed of graphite-containing cast iron is known from e.g. Patent Document 1.

Here, after removal of graphite from the surface through a chemical cleaning technique using molten salt solution immersion, a salt-bath nitriding treatment is effected for improving corrosion resistance of the component formed of graphite-containing cast iron.

### CITATION LIST

### Patent Literature

Patent Document 1: Japanese Examined Patent Application Publication No. 46-38891 (see FIG. 1).

### SUMMARY OF INVENTION

However, when the graphite-containing cast iron component disclosed in Patent Document 1 is employed in a disc rotor as a constituting component of a disc brake of a vehicle or the like, the salt-bath nitriding treatment results in formation of a porous layer. Then, water reaches the graphite of the disc rotor through pores of the porous layer, thus tending to invite rust generation around the graphite. Thus, the corrosion resistance was not necessarily satisfactory.

Therefore, the object of the present invention is to provide a disc rotor formed of graphite-containing cast iron and having high corrosion resistance.

The present inventors identified that in a disc rotor formed of graphite-containing cast iron, rust generation occurs readily in particular at graphite portions exposed in the sliding face of the disc rotor and then discovered that effecting a graphite removing treatment and a gas nitrocarburizing treatment is effective for preventing this, thus arriving at the present invention.

According to a first characterizing feature of a disc rotor relating to the present invention, there is provided a disc rotor formed of graphite-containing cast iron, wherein after removal of graphite present adjacent a surface of the disc rotor through a graphite removing treatment, a nitride layer and an oxynitride layer are laminated one after another on the surface through a gas nitrocarburizing treatment.

### FUNCTION AND EFFECT

With the above arrangement, after removal of graphite present adjacent a surface of the rotor through a graphite removing treatment, a nitride layer and an oxynitride layer are laminated one after another on the surface through a gas nitrocarburizing treatment. Hence, the graphite in the disc rotor surface is covered sufficiently by the nitride layer and the oxynitride layer. Therefore, even when the disc rotor is exposed to water, this water will hardly reach the graphite in the surface of the disc rotor, so that generation of rust can be prevented and high corrosion resistance can be provided.

According to a second characterizing feature of a disc rotor relating to the present invention, a surface-roughness adjustment treatment is effected after the gas nitrocarburizing treatment.

### FUNCTION AND EFFECT

With the above arrangement, the surface roughness (friction coefficient) of the disc rotor can be adjusted appropriately and also the surface can be provided with a certain degree of smoothness, whereby the aesthetic aspect of the disc rotor too can be improved.

### BRIEF DESCRIPTION OF DRAWINGS

FIG. 1 shows a flowchart of a manufacturing process of a disc rotor relating to an inventive Example,

FIG. 2 is a sectional structure microscopic photo (400 magnifications) of the disc rotor relating to the Example,

FIG. 3 is a sectional structure microscopic photo (1000 magnifications) of the disc rotor relating to the Example,

FIG. 4 is a sectional structure microscopic photo (400 magnifications) of a disc rotor relating to Comparison Example 1 (un-treated),

FIG. 5 is a sectional structure microscopic photo (1000 magnifications) of the disc rotor relating to Comparison Example 1 (un-treated),

FIG. 6 is a sectional structure microscopic photo (400 magnifications) of a disc rotor relating to Comparison Example 2 subjected to a nitrocarburizing treatment alone),

FIG. 7 is a sectional structure microscopic photo (1000 magnifications) of the disc rotor relating to Comparison Example 2 (subjected to a nitrocarburizing treatment alone),

FIG. 8 is a sectional structure microscopic photo (400 magnifications) of a disc rotor relating to Comparison Example 3 (subjected to a salt-bath nitriding treatment),

FIG. 9 is a sectional structure microscopic photo (1000 magnifications) of the disc rotor relating to Comparison Example 3 (subjected to a salt-bath nitriding treatment),

FIG. 10 is a view for explaining a mechanism of rust development on a surface of a conventional disc rotor,

FIG. 11 is a scanning type electron microscopic photo (SEM) of a section of the conventional disc rotor,

FIG. 12 is a graph showing changes in sticking torque of a frictional member to a disc rotor in an actual vehicle, and

FIG. 13 is a graph showing changes in noise levels when the frictional member is stuck to the disc rotor in the actual vehicle.

### DESCRIPTION OF EMBODIMENTS

Next, an embodiment of the present invention will be explained.

A disc rotor relating to the present invention is a circular disc-like component constituting one member included in a disc brake of a vehicle. In operation, when the disc brake is used for generating a braking force, a brake pad having a frictional material and a back plate is pressed against a side face.

The disc rotor relating to the present invention is characterized in that a cast material of the disc rotor is manufactured by casting using graphite-containing cast iron and then formed into a predetermined shape by a machining work, then, graphite present in the vicinity of the surface is removed by a graphite removing treatment and further on the resultant surface, a nitride layer and an oxynitride layer are laminated one after another through a gas nitrocarburizing treatment.

As the graphite-containing cast iron used as the material, an ordinary cast iron used in the manufacture of a conventional disc rotor can be employed. As some non-limiting examples of such cast iron, flakey graphite cast iron, spheroidal graphite cast iron, etc. can be cited.

Further, as to the casting and the machining work, these can be effected according to the known techniques effected in the manufacture of the conventional disc rotor.

The graphite removing treatment can be effected in accordance with a chemical cleaning method by molten-salt immersion. In effecting this, it is preferred however that a temperature condition from 400° C. to 500° C. and a treatment period from 1 hour to 2 hours be used.

The gas nitrocarburizing treatment can be effected in accordance with the known gas nitrocarburizing technique. In effecting this, it is preferred however that a temperature condition from 550° C. to 650° C. and a treatment period from 1 hour to 3 hours be used.

Through this gas nitrocarburizing treatment, on the surface of the disc rotor, a nitride layer and an oxynitride layer are formed one after another, thus being laminated thereon. In this, it is preferred that the nitride layer have a thickness ranging from 5 μm to 25 μm and the oxynitride layer have a thickness ranging from 1 μm to 10 μm.

With the disc rotor relating to the present invention, if necessary, a surface roughness adjustment treatment can be effected after the gas nitrocarburizing treatment. Through this surface roughness adjustment treatment, sludge or the like that is invisible for naked eyes is removed from the surface of the disc rotor after the gas nitrocarburizing treatment and also unevenness, if any present, on the surface is averaged to a certain extent for smoothing-out, so that the surface roughness (friction coefficient) can be adjusted as desired.

The surface roughness adjustment treatment can be effected in accordance with the known beads-shot technique. In effecting this, it is preferred however that an average particle diameter of glass beads range from 50 μm to 100 μm and an injection pressure range from 1 kg to 4 kg pressure and an injection period be set to 3 minutes or shorter.

Further, it is also preferred that the surface hardness of the disc rotor past the three steps of the graphite removing treatment, the gas nitrocarburizing treatment and the surface roughness adjustment treatment range from Hv 690 to 1150.

### EXAMPLE

Now, an example (Example) of the inventive disc rotor will be explained.

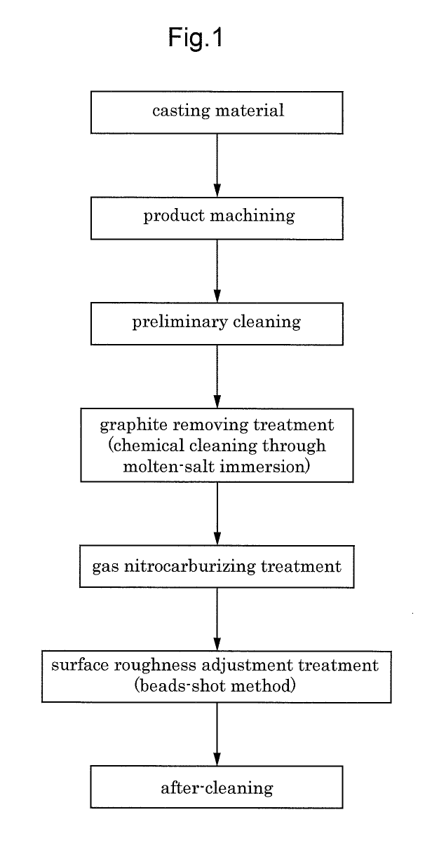

A disc rotor according to the present invention was manufactured according to a manufacturing flow shown in FIG. 1.

As graphite-containing cast iron, flakey graphite cast iron was employed. Then, a casting material for the disc rotor was fabricated by casting. And, this material was worked into a predetermined circular disc-like shape through a machining operation. Then, on this, a preliminary cleaning operation was effected.

Next, as the graphite removing treatment, a chemical cleaning treatment through molten-salt immersion was effected (temperature: 450±10° C., period: 60±10 minutes) to remove graphite present near the surface. Further, through a gas nitrocarburizing treatment (temperature: 580±10° C., period: 120±5 minutes, gas species: mixture containing nitrogen as the base, with ammonia or carbon dioxide added thereto), a nitride layer and an oxynitride layer are laminated one after another on the surface.

Further, as the surface roughness adjustment treatment, a beads-shot operation (glass beads: average particle diameter 75 μm, injection distance: 200 mm, injection force: 2 kg pressure, injection period: 90 seconds) was effected for adjustment of the surface roughness. Thereafter, an after-cleaning operation was effected for completing the disc rotor.

Further, various comparison examples (Comparison Examples) as follows were manufactured.

### (1) Comparison Example 1 (Un-Treated)

Like Example above, as graphite-containing cast iron, flakey graphite cast iron was employed. Then, a casting material for the disc rotor was fabricated by casting. And, this material was worked into a predetermined circular disc-like shape through a machining operation and then a preliminary cleaning operation was effected. But, this time, the subsequent operations, i.e. the graphite removing treatment, the gas nitrocarburizing treatment and the surface roughness adjustment treatment were not effected.

### (2) Comparison Example 2 (Gas Nitrocarburizing Treatment Only)

Like Example above, as graphite-containing cast iron, flakey graphite cast iron was employed. Then, a casting material for the disc rotor was fabricated by casting. And, this material was worked into a predetermined circular disc-like shape through a machining operation and then a preliminary cleaning operation was effected. Thereafter, only the gas nitrocarburizing treatment was effected.

### (3) Comparison Example 3 (Salt-Bath Nitriding Treatment)

Like Example above, as graphite-containing cast iron, flakey graphite cast iron was employed. Then, a casting material for the disc rotor was fabricated by casting. And, this material was worked into a predetermined circular disc-like shape through a machining operation and then a preliminary cleaning operation was effected. Thereafter, the salt-bath nitriding treatment disclosed in the U.S. Patent Application Publication No. 2008/0000550 was effected.

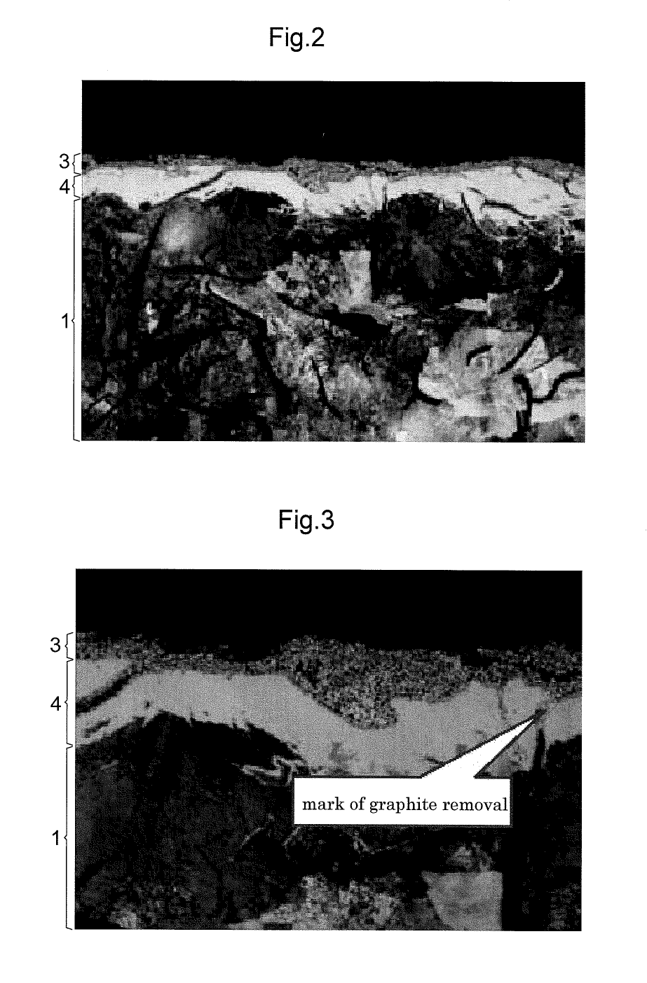

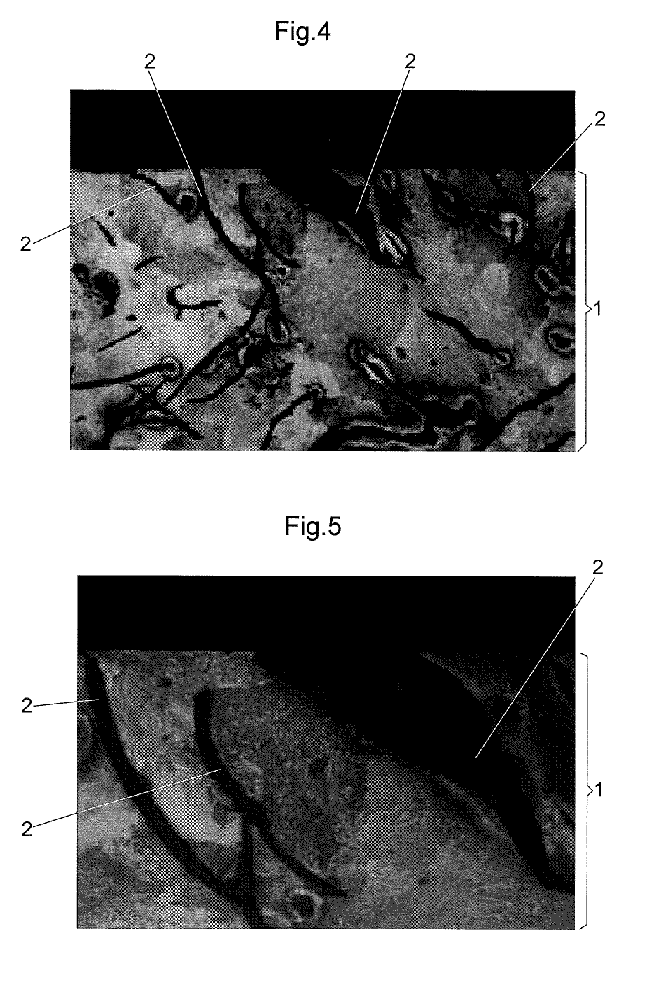

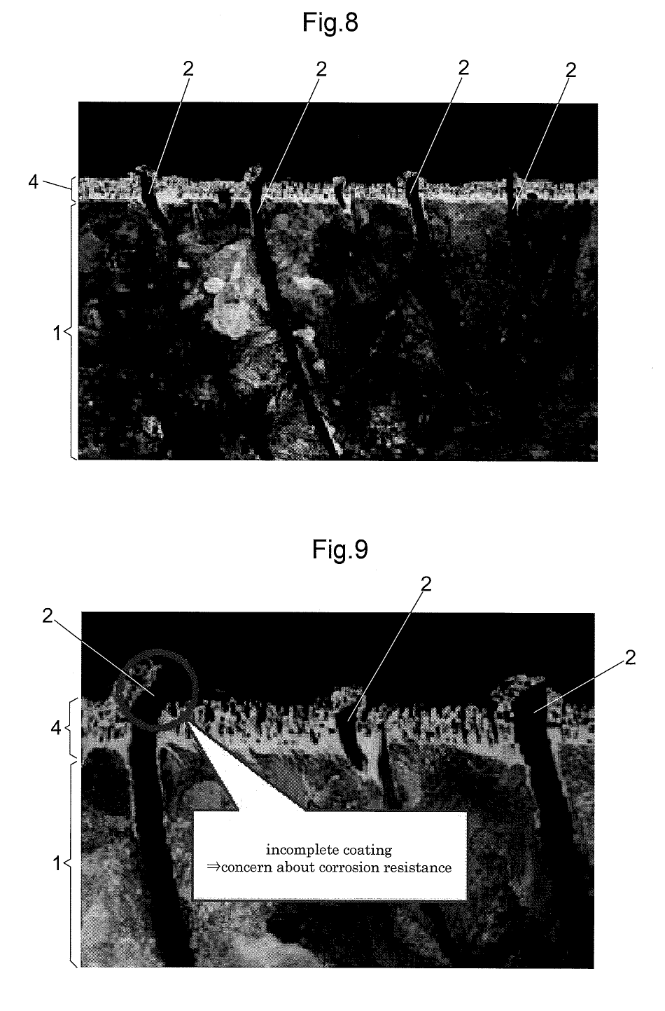

The sectional structure microscopic photos respectively of the inventive Example and Comparison Examples 1-3 are shown in FIGS. 2-9 and the respective properties thereof are shown in Table 1 below. Referring to reference marks shown in FIGS. 2-9, numeral 1 denotes a disc rotor material, numeral 2 denotes graphite, numeral 3 denotes oxynitride layer, and numeral 4 denotes nitride layer, respectively.

TABLE 1

| | | Comparison | Comparison | Comparison |
|---|---|---|---|---|
| | Example | Example 1 | Example 2 | Example 3 |
| condition of | sufficiently | generally | incompletely | incompletely |
| graphite | coated | exposed | coated | coated |
| coating on | | | | |
| surface | | | | |
| presence of | NO | YES | YES | YES |
| graphite on | | | | |
| surface | | | | |
| presence of | YES | NO | YES | NO |
| oxynitride | (about | | (about 2.0 μm) | |
| layer | 5.0 μm) | | | |
| (layer | | | | |
| thickness) | | | | |
| presence of | YES | NO | YES | YES |
| nitride layer | (9.0-20.0 | | (6.0-13.0 μm: | (6.0-12.0 |
| (layer | μm: average | | average | μm: average |
| thickness) | 13.0 μm) | | 7.0 μm) | 7.5 μm) |
| surface | Hv992 | Hv150-240 | Hv792 | Hv662 |
| roughness | | | | |

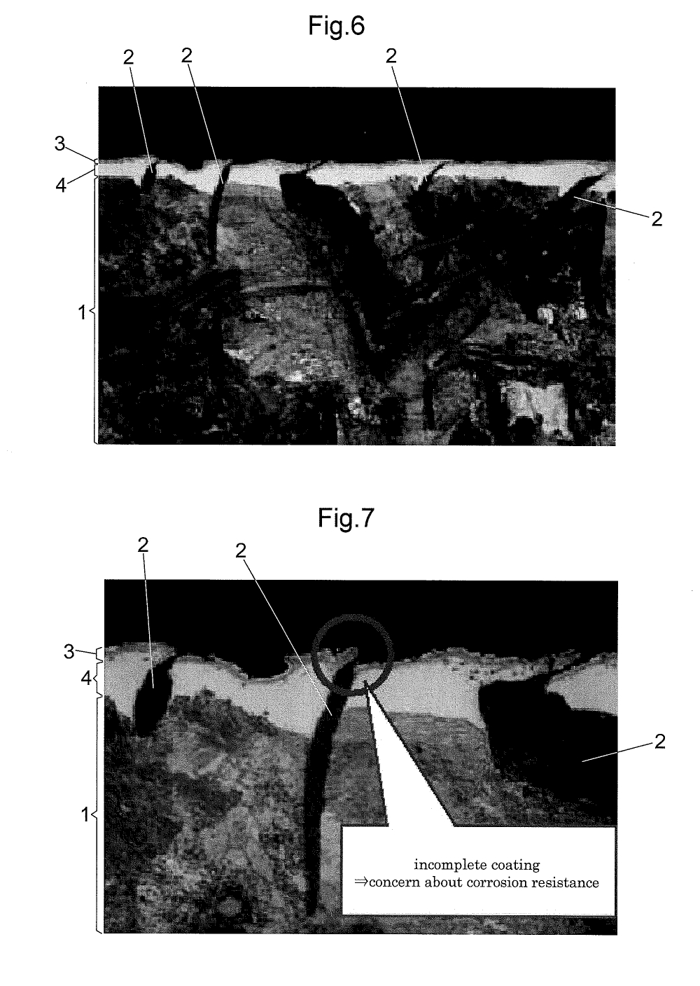

As shown in FIG. 2 and FIG. 3, in the inventive Example, thanks to the implementation of the graphite removing treatment and the gas nitrocarburizing treatment, graphite was hardly left exposed on the surface of the disc rotor material. However, as shown in FIGS. 6 through 9, as to Comparison Examples 2 and 3 wherein a nitriding treatment alone was implemented without implementation of the graphite removing treatment, graphite coatings on the disc rotor material surfaces were found incomplete, thus raising concern about the corrosion resistance.

### [Performance Test]

Here, there will be explained a mechanism of occurrence of “sticking” between a disc rotor and a brake pad in a disc brake.

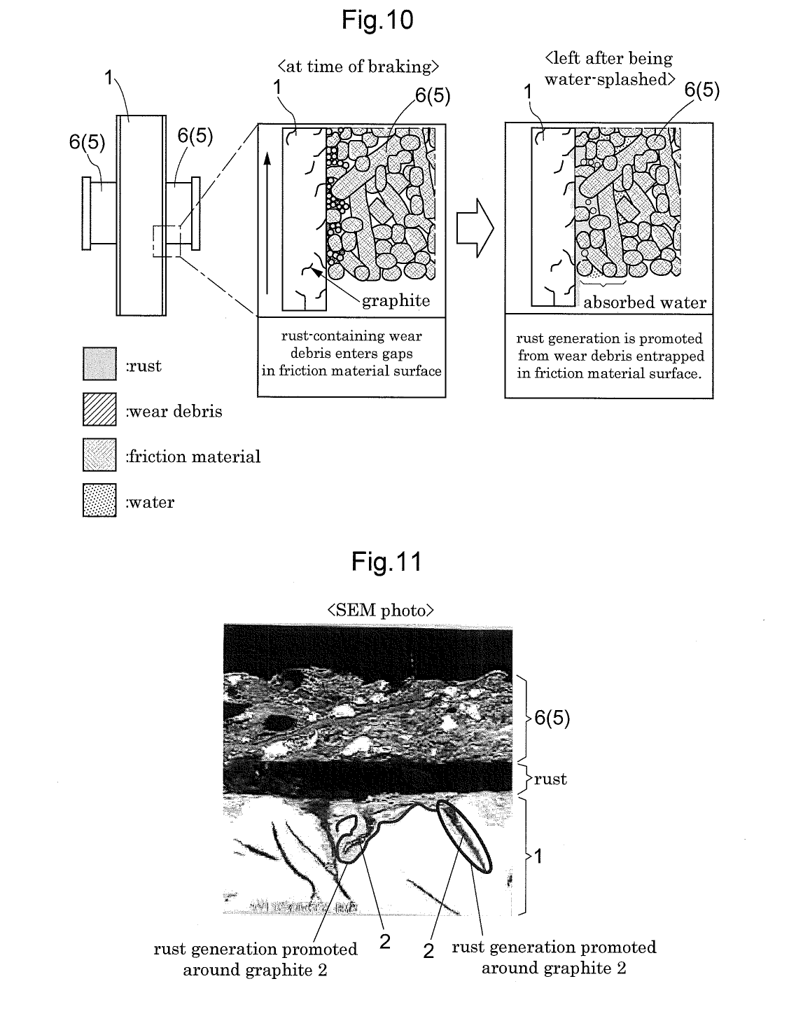

As illustrated in FIG. 10, in the event of generation of rust on the surface of the disc rotor, when the friction material of the brake pad is pressed against a side face of the disc rotor at the time of generation of a braking force from the disc brake, wear debris containing the rust will enter gaps present in the friction material surface. Then, if the disc brake is exposed to water under this condition, this water will be absorbed into the wear debris entrapped in the gaps present in the friction material surface and generation of rust from the wear debris is promoted, so that the disc rotor and the brake pad will be stuck to each other.

In the above, as illustrated in FIG. 11, the water absorbed in the wear debris will permeate to the inside through graphite exposed on the disc rotor surface. Hence, the generation of rust will be promoted in particular around the graphite.

Therefore, with the promotion of rust generation on the surface of the disc rotor, sticking of the brake pad to the disc rotor can occur more easily. Then, in an actual vehicle, there will occur rise in the sticking torque as well as rise in the noise level at the time of sticking.

Then, in this performance test, the disc rotor according to the inventive Example and the disc rotor according to the Comparison Example 1 were mounted respectively to a disc brake of an actual vehicle. Then, under the following testing environment tending to invite rust generation, the disc rotors were compared through determinations of the sticking torques and sticking noise levels for a period slightly shorter than one month.

### (Testing Method)

In the first evaluation, the following steps (1) through (5) were effected in this order and in the second evaluation and evaluations thereafter, the steps (6) through (10) were effected in repetition.

(1) mutual grinding

(2) water splashing

(3) braking for a few times

(4) outdoor leaving

(5) determining sticking torque and noise level

(6) mutual grinding

(7) water splashing

(8) braking for a few times

(9) outdoor leaving

(10) determining sticking torque and noise level

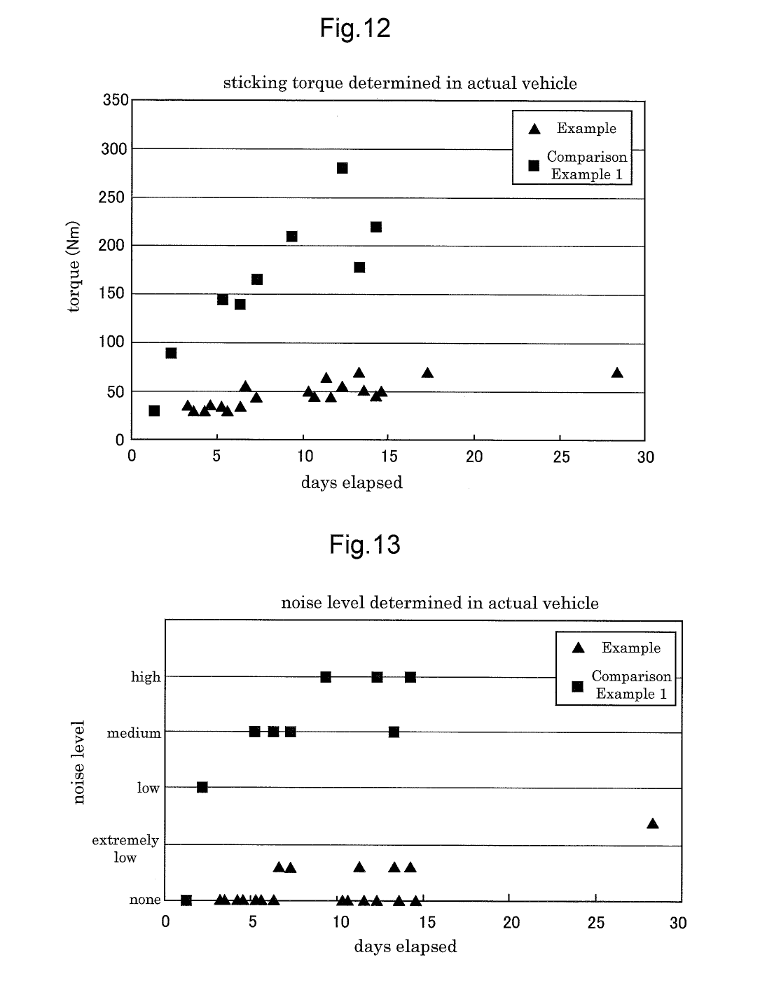

As illustrated in FIG. 12, in Comparison Example 1, the sticking torque exceeded 200 Nm upon lapse of about 9 days after the start of testing. Hence, it is believed that rust generation readily occurs. On the other hand, in the inventive Example, there was observed no rise in the sticking torque even after lapse of 25 days after the start of testing, suggesting low possibility of rust generation.

Further, as illustrated in FIG. 13, in Comparison Example 1, high level of noise was determined from immediately after the start of testing. Whereas, substantially no rise in the noise was observed with the inventive Example. This too suggests the high possibility of rust generation in Comparison Example 1 and low possibility of rust generation in the inventive Example.

### INDUSTRIAL APPLICABILITY

The disc rotor according to the present invention is applicable to a disc brake of e.g. a vehicle.

1. A disc rotor formed of graphite-containing cast iron, wherein after removal of graphite present adjacent a surface of the disc rotor through a graphite removing treatment, a nitride layer and an oxynitride layer are laminated one after another on the surface through a gas nitrocarburizing treatment.

2. The disc rotor according to claim 1, wherein a surface-roughness adjustment treatment is effected after the gas nitrocarburizing treatment.
